(19) United States
(12) Patent Application Publication
(10) Pub. No.: US 2024/0371577 A1
(43) Pub. Date: Nov. 7, 2024

(54) CONTACT ELEMENT OF A MEMS RELAY

(71) Applicant: Robert Bosch GmbH, Stuttgart (DE)

(72) Inventors: Bernd Klein, Reutlingen (DE); Jochen Reinmuth, Reutlingen (DE); Matthew Lewis, Reutlingen (DE); Peter Schmollngruber, Aidlingen (DE)

(21) Appl. No.: 18/688,406

(22) PCT Filed: Jan. 9, 2023
(86) PCT No.: PCT/EP2023/050334

§ 371 Date: Mar. 1, 2024

(30) Foreign Application Priority Data
Jan. 13, 2022 (DE) 10 2022 200 336.5

(51) Int. Cl. H01H 1/00; H01H 1/14; H01H 11/04

(52) U.S. Cl. CPC H01H 1/0036; H01H 1/14; H01H 11/04

(57) ABSTRACT

A contact element of a MEMS relay. The contact element includes a defined number greater than one of electrically conductive contact bodies, wherein the contact bodies are arranged at least partially within a layer that is plastically deformable in a defined manner, wherein a hardness of the plastically deformable layer is less than a hardness of the contact bodies, wherein, by exerting a compressive force on the contact bodies, the contact bodies can be pressed into the plastically deformable layer and brought to a substantially uniform height level, and wherein the plastically deformable layer is arranged at least partially within an insulation layer.

### FIELD

The present invention relates to a contact element for a MEMS relay. The present invention also relates to a method for producing a contact element for a MEMS relay.

### BACKGROUND INFORMATION

Conventional relays are driven via a magnetic coil, have a defined, non-negligible, electrical current consumption in the switched-on state, and are relatively large. Mechanical switching forces of such relays are very high and low contact resistances can therefore be achieved in the switched-on state. The service life of these relays is in particular limited when these relays are frequently switched off with an inductive load.

This is because, during the switch-off operations, sparkovers can occur, which can damage the contact surfaces and adversely affect a service life of the relays.

Capacitively driven MEMS relays have also recently become available. They are clearly smaller in comparison to the relays mentioned above and have a significantly lower electrical current consumption in the ON state due to the capacitive drive. However, only small forces can be produced via the capacitive deflection; relays with particularly small contact resistances are therefore in particular more difficult to realize.

With higher forces, the quasi-rough surfaces can be better pressed onto one another and, with the larger surface, a lower contact resistance is also achieved. Furthermore, the flashovers produced by inductive loads during the switch-off operation can lead to material displacement. This results in a significant increase in roughness on the actually very smooth surfaces, which immediately leads to a strong increase in the contact resistance due to the low capacitive forces. Conventional MEMS relays therefore virtually cannot switch any inductive loads.

Furthermore, it is possible to connect many small relays with small contact surfaces in parallel in order on the one hand to become more insensitive to flashovers in this way since only individual relays are damaged thereby, and in order on the other hand to achieve an effectively lower roughness through the smaller contact surfaces. However, this approach can only achieve gradual improvement. In turn, this is paid for by an increased space requirement and thus with increased costs for the MEMS component since a single MEMS relay element can be designed to be smaller than many individual MEMS relay elements that in total generate the same force.

### SUMMARY

An object of the present invention is to provide an improved contact element for a capacitively controlled MEMS relay.

The object may be achieved according to a first aspect of the present invention with a contact element of a MEMS relay. According to an example embodiment of the present invention, the contact element includes a defined number greater than one of electrically conductive contact bodies, wherein the contact bodies are arranged at least partially within a layer that is plastically deformable in a defined manner, wherein a hardness of the plastically deformable layer is less than a hardness of the contact bodies, wherein, by applying a compressive force to the contact bodies, the contact bodies can be pressed into the plastically deformable layer and brought to a substantially uniform height level, and wherein the plastically deformable layer is arranged at least partially within an insulation layer.

According to an example embodiment of the present invention, the height level of the contact bodies of the contact element can be adjusted by means of the plastically deformable layer so that the contact bodies can be brought to a uniform height level. This allows improved contacting of the contact bodies with corresponding contacts of a contact structure that can be moved in the MEMS relay to the contact element. This can improve the functionality of the MEMS relay. In particular, differences in the height level can be evened out during operation of the MEMS relay by performing a readjustment of the height level of the contact bodies. For this purpose, a compressive force can be exerted on the contact bodies by means of a contact structure of the relay, whereby the contact bodies are pressed into the plastically deformable layer and brought to a uniform height level with respect to the contact structure.

According to the present invention, the hardness of the material of the contact bodies and of the material of the plastically deformable layer is defined as Brinell hardness or as Vickers hardness.

According to the present invention, the contact bodies can be made of a material that has at least two times the hardness of the material of the plastically deformable layer. The hardness of the material of the contact bodies can, for example, have a Brinell hardness of at least 1000 MPa, while the material of the plastically deformable layer has a Brinell hardness of less than 800 MPa. In particular, the material of the plastically deformable layer can be designed with a higher ductility than the material of the contact bodies. The compression modulus of the materials of the contact bodies and of the plastically deformable layer can be identical or nearly identical. In particular, the compression modulus of the material of the contact bodies is at least as large as the compression modulus of the material of the plastically deformable layer. In addition, it can be advantageous if the material of the plastically deformable layer has a low brittleness and low or no contamination with crystal structures.

An advantageous development of the contact element of the present invention provides that the contact bodies have elongated or round cross-sections. In this way, great freedom of design for the contact element is advantageously supported.

A further advantageous development of the contact element of the present invention provides that the plastically deformable layer is exposed on a top side. Here, “exposed” means that the insulation layer is not formed at least on portions of the top side of the plastically deformable layer. The plastically deformable layer can thus spread via the exposed top side when the contact bodies are pressed into the plastically deformable layer.

A further advantageous development of the contact element of the present invention provides that the plastically deformable layer is arranged completely within the insulation layer. For this purpose, the insulation layer has recesses or holes. The contact bodies are in this case arranged in the recesses/holes and connected to one another via the common plastic deformable layer, which is continuously formed underneath the insulation layer. The contact bodies can furthermore be moved relative to the insulation layer. Contact bodies at a higher height level can thus be pressed into the plastically deformable layer by applying a compressive force to the contact bodies. At the same time, as a result of the plastically deformable layer that is displaced by pressing the contact body, contact bodies at a lower height level are pressed upward out of the insulation layer by the plastically deformable layer. By simultaneously pressing different contact bodies into the plastically deformable layer and out of the plastically deformable layer, the contact bodies can be adjusted to a uniform height level. By completely covering the plastically deformable layer with the insulation layer, electrical flashovers from the contact structure to the plastically deformable layer can furthermore be suppressed.

A further development of the contact element of the present invention provides that the contact bodies are arranged on separated elements of the plastically deformable layer. Advantageously, individual contacts are provided in this way, which realize a sum contact with other individual contacts. In this case, the individual contacts do not have any electrical and/or tactile contact to one another.

A further advantageous development of the contact element of the present invention provides that the separated elements of the plastically deformable layer are laterally at least partially exposed. The plastically deformable layer can in this case “act” toward both sides. Advantageously, the MEMS relay can be operated with lower forces as a result. Through the individual, separated elements of the plastically deformable layer, the layer can spread laterally when the contact bodies are pressed into the layer, and can thus be pushed away laterally in order to make room for the contact body.

A further development of the present invention provides that the plastically deformable layer has at least a thickness that corresponds to at least one half of a width of the contact bodies. As a result, good plastic deformability of the plastically deformable layer and good inelastic movability of the contact bodies can be achieved.

A further development of the present invention provides that a height of the contact bodies corresponds to at least double the radii of the contact bodies. As a result, it can be achieved that an electric field strength required for operating the relay can be achieved when the contact bodies are contacted with corresponding contact structures of the relay. A contact structure can in this case be designed analogously to a contact element according to the present invention.

A further development of the contact element of the present invention provides that at least one hollow space is respectively formed within the separated elements of the plastically deformable layer. When the contact bodies are pressed into the plastically deformable layer, the layer can be pressed into the hollow space in order to be able to make room for the respective contact body.

A further advantageous development of the contact element of the present invention provides that the material of the plastically deformable layer comprises aluminum, copper, gold or silver. According to the advantageous embodiment, the material of the contact bodies comprises tungsten, ruthenium or molybdenum. The contact bodies thus have a significantly greater hardness than the plastically deformable layer and can be pressed undamaged into the plastically deformable layer. In particular, the material of the plastically deformable layer has a significantly higher ductility than the material of the contact bodies.

A further advantageous development of the present invention provides that exposed surfaces of the contact bodies are approximately <2 μm and that edge radii of the contact bodies are approximately <0.5 μm. As a result of these dimensions, very small contacts with a smooth surface are ultimately provided.

A further advantageous development of the contact element of the present invention provides that the contact bodies are arranged at a distance of approximately <10 μm to one another. Advantageously, as a result of this small distance between the contact elements, only a small amount of force is required to displace the plastically deformable material. A further development of the contact element of the present invention provides that the contact bodies are arranged in an array. A further development of the present invention provides that a total number of the contact bodies is such that it results in an electrical target resistance of the contact element.

In a further advantageous development of the contact element of the present invention, the contact bodies are coated with a material that substantially prevents oxide formation on the surface of the contact bodies. Advantageously, improved performance of the contact bodies is thereby supported.

According to a further aspect of the present invention, a method for leveling contact bodies of a contact element of a MEMS relay is provided. According to an example embodiment of the present invention, for leveling, the contact bodies are subjected to a compressive force and thus pressed into the plastically deformable layer. For applying the compressive force, a contact structure that can be moved to the contact element of the relay is brought to strike against the contact bodies of the contact element. Through the impact, the contact bodies are subjected to the compressive force and pressed into the plastically deformable layer. The method for leveling can in this case be carried out at the factory directly after manufacturing the MEMS relay in order to condition and set the relay. Alternatively or additionally, the method can be carried out during operation of the relay in order to even out differences in the height level caused by the operation.

According to a further aspect of the present invention, the object may be achieved with a method for producing a contact element for a MEMS relay according to the present invention, comprising the steps of:
depositing and structuring a plastically deformable layer;
depositing an insulation layer onto the structured, plastically deformable layer;
carrying out a planarization step;
introducing holes into the insulation layer;
filling the holes with an electrically conductive material, wherein the electrically conductive material has a greater hardness than the material of the plastically deformable layer;
carrying out a polishing step of the electrically conductive material with a stop on the insulation layer;
removing the insulation layer.

According to an example embodiment of the present invention, the method can further comprise:
carrying out a planarization step.

The introduction of holes into the insulation layer can, for example, take place by means of an etching process. This enables simple and precise introduction of holes.

Removal can take place by means of isotropic etching. This enables precise and simple removal of the insulation layer.

The present invention is described in detail below with further features and advantages on the basis of several figures. Identical or functionally identical elements have identical reference signs. The figures are in particular intended to illustrate the main principles of the present invention and need not necessarily be designed to scale for this purpose.

Disclosed device features result analogously from corresponding disclosed method features, and vice versa. This means, in particular, that features, technical advantages and embodiments relating to the contact element for a MEMS relay and the method for producing the contact element apply equally.

### BRIEF DESCRIPTION OF THE DRAWINGS

FIG. 1 shows a conventional MEMS relay.

FIGS. 2-8 show an embodiment of a contact element of the present invention.

FIGS. 9-14 shows a cross-sectional view of a method for producing a proposed contact element;

FIG. 15 shows a block diagram of a MEMS relay with the contact element according to the present invention.

FIG. 16 shows a principal flow of an example method for producing a contact element, according to the present invention.

### DETAILED DESCRIPTION OF EXAMPLE EMBODIMENTS

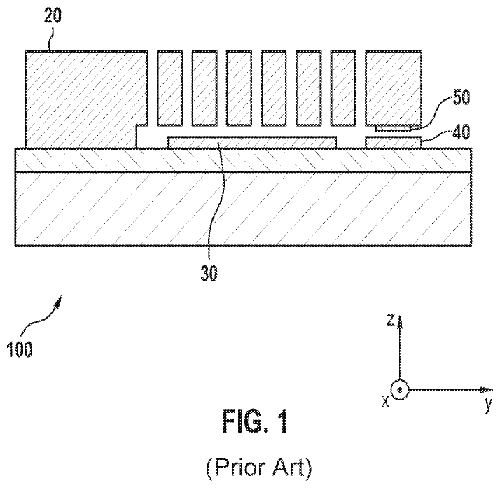

FIG. 1 shows a highly simplified cross-sectional view of a conventional MEMS relay, which is, for example, produced by Analog Devices®. It is constructed in such a way that a first electrode 30 and a first contact surface 40 are provided on a substrate 1. A lever element 20 is arranged, separated by a distance, above both elements 30, 40. If an electrical voltage is applied between the lever element 20 and the first electrode 30, an out-of-plane movement (in the z-direction) occurs, wherein the lever element 20 is deflected and a contact between the lever element 20 and a second contact surface 50 is produced.

For the present invention, for improving the related art, it is proposed to provide a contact element with narrow point-shaped or linear contact bodies at least on one contact side of the MEMS relay 100. In this respect, it is proposed to form the contact bodies with a flat surface, which have a sharp edge or very small rounding on the edge. As a result of the sharp edges and the flat surfaces, strong electric fields can be produced due to this specific geometry during a striking operation or a contacting operation with a contact structure of the relay that can be moved relative to the contact element, whereby spark formation is directed away from the surface onto the edge and a flashover takes place outside the actual contact region.

Advantageously, the contact bodies can be formed as contact points or lines from a very hard material, in particular tungsten, ruthenium, molybdenum, or the like. The contact bodies can furthermore be arranged at least partially in a plastically deformable layer, wherein the plastically deformable layer has a lower hardness than the contact bodies. The latter can thus be pressed into the plastically deformable layer by applying a compressive force.

The plastically deformable layer can, for example, be made of a plastically deformable material that preferably comprises aluminum, copper or gold.

Furthermore, a production method for the contact element is proposed, with which particularly sharp edges and smooth contact surfaces of uniform height can be produced.

Some advantages of the proposed contact element 10a . . . 10n are listed below merely by way of example:
The proposed production method allows particularly smooth surfaces of uniform height for the proposed contact element 10a . . . 10n, as a result of which large effective contact surfaces and thus low contact resistances can be achieved with low forces.
The proposed production method furthermore allows contact elements with very small contact bodies 1a . . . 1n to be produced, as a result of which advantageously large mechanical contact pressures and thus low contact resistances can ultimately be achieved.

Minimal height differences of the proposed contact bodies 1a . . . 1n can be evened out in operation by a soft support pad on which the “hard” contact bodies 1a . . . 1n are supported. In particular, the use of a plastic material even allows an improvement of the contact resistance in operation, wherein this effect can also be specifically used to condition the component prior to delivery.
Despite the soft suspension of the contact surfaces, a hard and highly flashover-resistant material can be used for the contact bodies 1a . . . 1n.
The shape of the contact bodies 1a . . . 1n ensures that the contact surfaces of the contact bodies 1a . . . 1n cannot be damaged in the event of flashovers.
During operation, damage to the contact surfaces on individual contact bodies 1a . . . 1n, for example by flashovers or other effects, can be evened out by pressing the respective contact body 1a . . . 1n into the soft support pad of the plastically deformable layer 2.

The number of three contact bodies 1a , 1b, 1c shown in the figures below is merely exemplary. It is understood that a contact element 10a . . . 10n can also have less or more than the three contact bodies 1a . . . 1n shown.

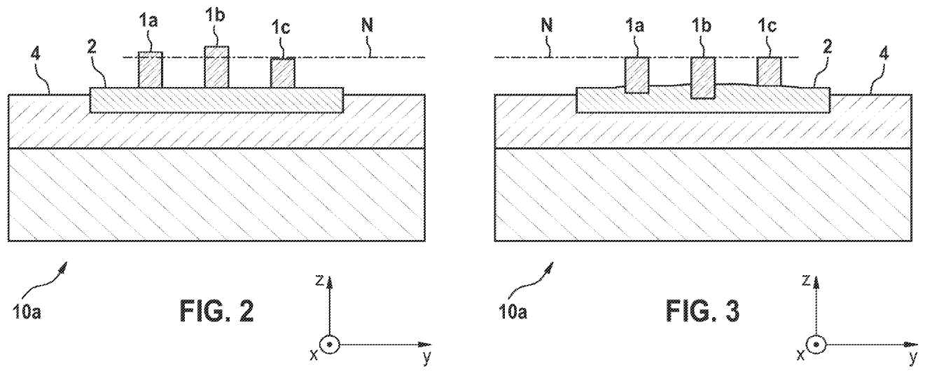

FIG. 2 shows an embodiment of a proposed contact element 10a comprising three contact bodies 1a, 1b, 1c, in which a base structure and functionality can be seen well. Contact bodies 1a . . . 1c are formed from an electrically conductive material that has a greater hardness than the plastically deformable layer 2. The material of the plastically deformable layer 2 can in particular have a higher deformability than the material of the contact bodies. The compression modulus on the other hand can be the same for both materials. In particular, the hardness of the material of the contact body can have two times the hardness of the material of the plastically deformable layer 2. The material of the contact bodies 1a, 1b, 1c can, for example, comprise tungsten, ruthenium or molybdenum. The plastically deformable layer 2 can, for example, comprise aluminum, gold or copper. The contact bodies 1a . . . 1n have different heights to a greatly exaggerated extent. The height of the contact bodies 1a . . . 1n here refers to an extension in the z-direction of the coordinate system shown. If the contacts come into contact with a planar surface, they can be pressed into the plastically deformable layer 2 (e.g., made of aluminum), as shown in principle in FIG. 3. In plan view, a cross-section of the contact bodies 1a . . . 1n can be circular, elongated, elliptical or otherwise geometrically suitable. In the case of elongated contact bodies 1a . . . 1n, a type of “contact lines” are thus provided. A total number of the contact bodies 1a . . . 1n is selected in such a way that they realize an electrical target resistance of the entire contact element 10a . . . 10n. For electrically insulating the contact element 10a, the plastically deformable layer 2 is here at least partially embedded in an insulation layer 4. In the embodiment shown in FIGS. 2 and 3, a top side in the z-direction of the plastically deformable layer 2 is free of the insulation layer.

It can be seen in the contact body 1b of FIG. 3 that the aluminum material of the plastically deformable layer 2 is displaced and can spread laterally upward or can also raise one of the other contact bodies 1a, 1c. As a result of the plastically deformable layer 2 spreading laterally, the contact bodies 1a, 1b, 1c can be pressed into the plastically deformable layer 2 by exerting a compressive force in the negative Z-direction. The contact bodies 1a, 1b, 1c can thereby be brought to a uniform height level relative to the Z-direction. In order to keep flashovers away from the contact surfaces, it can be beneficial to keep the radius of the edges of the contact points less than 20% of the extension of the contact surfaces of the contact bodies 1l . . . 1n in order to build an adequately large electric field on the edges of the contact bodies 1a . . . 1n. In this case, exposed surfaces of the contact bodies have a length of approximately <2 μm and edge radii of the contact bodies 1a . . . 1n are approximately <0.5 μm.

Furthermore, it can be beneficial to keep the height in the z-direction of the contact bodies 1a . . . 1n or lines at least twice as large as the radius of the edges in order to build an adequate electric field on the edges. In order to achieve a particularly plastically deformable movement, it can be beneficial for the thickness of the aluminum layer to be at least half the width of the contact bodies 1a . . . 1n.

In order to prevent flashovers to the aluminum layer, it can also be beneficial to provide a complete cover with an insulation layer 4 (e.g., oxide material) above the plastically deformable aluminum layer 2. In order to achieve a good, plastically deformable movement, it is beneficial to place the contact bodies 1a . . . 1n close to one another in relation to the thickness of the aluminum layer.

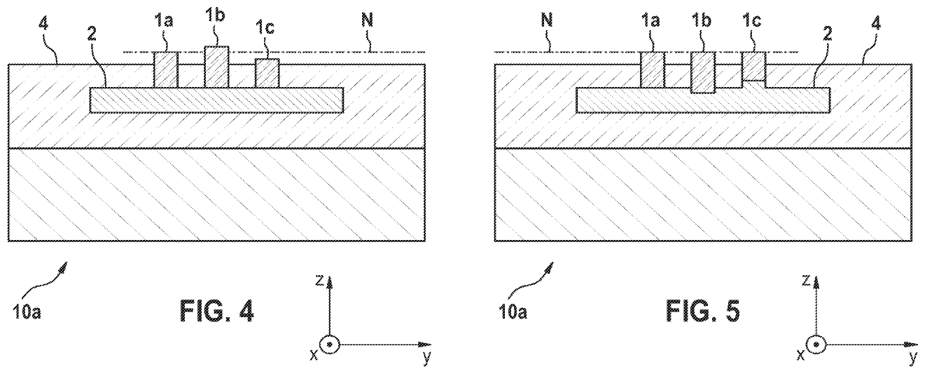

This covering of the plastically deformable layer 2 with the insulation layer 4 is shown in principle in FIGS. 4 and 5. The contact bodies 1a, 1b, 1c are here arranged in apertures or holes of the insulation layer 4. The contact bodies 1a, 1b, 1c can be moved in the z-direction relative to the insulation layer. The various contact bodies 1a, 1b, 1c are in this case connected to one another via the plastically deformable layer 4.

As shown in FIG. 5, the height of the contact bodies 1a, 1b, 1c can be achieved by exerting a compressive force and by pressing contact bodies 1a, 1b, 1c into the plastically deformable layer 2. In this case, it can be beneficial to select a distance between the contact bodies 1a . . . 1n to be smaller than approximately three times the thickness of the plastically deformable layer 2. The thickness of the plastically deformable layer 2 here refers to the extension of the layer 2 in the z-direction. It can furthermore be seen in FIG. 5 that electrical contact surfaces of the contact bodies 1a . . . 1n are arranged at an identical level N with respect to the z-direction. This arrangement at the same level N is achieved in an optional final production step in which the contact bodies are subjected to a defined force by means of a tool that encompasses all contact bodies 1a . . . 1n. Alternatively, the uniform height level of the plurality of contact bodies 1a, 1b, 1c can also be achieved by striking a contact structure of the MEMS relay that can be moved relative to the contact element 10a . . . 10n, against the contact bodies 1a . . . 1n. By striking the contact structure against the contact bodies 1a . . . 1n, the latter can be subjected to a compressive force. The applied compressive force causes the 15 Substitute Specification contact bodies 1a . . . 1n to be pressed into the plastically deformable layer 2. The contact bodies 1a . . . 1n can thereby be brought to a uniform height level in relation to the movable contact structure. This enables uniform and simultaneous contacting of the contact body 1a . . . 1n by contacts of the contact structure. In this case, the contact structure can in particular be designed as a further contact element 10a . . . 10n with contact bodies 1a . . . 1n.

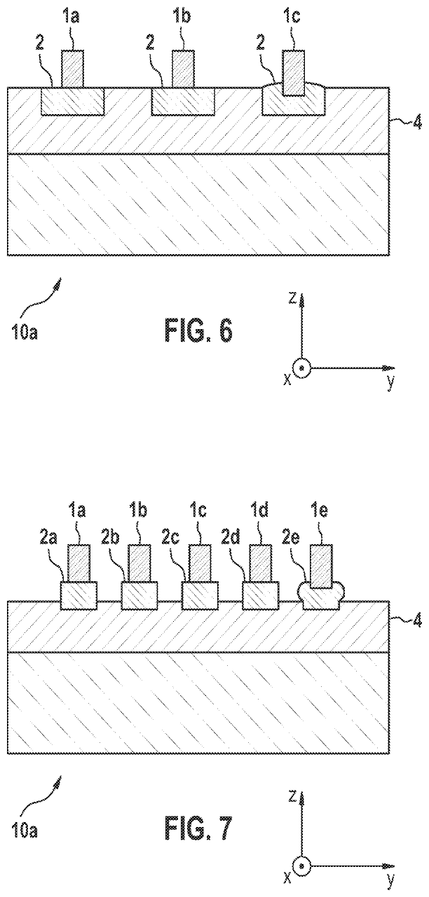

If greater distances between the contact bodies 1a . . . 1n without a continuous aluminum layer between the contact bodies 1a . . . 1n are desired, it can be beneficial to leave at least half the thickness of the plastically deformable layer 2 open next to the contact bodies 1a . . . 1n and without an insulation layer cover, as is indicated in principle in the embodiment of the contact element 10a of FIG. 6.

If small distances between the contact bodies 1a . . . 1n or lines without a continuous, plastically deformable layer 2 between the contact bodies 1a . . . 1n are desired, it can be beneficial to remove the insulation layer 4 at least up to half the height of the plastically deformable layer 2 in order to give the plastically deformable layer 2 the possibility of spreading laterally, as shown in the embodiment of the contact element 10a of FIG. 7. It can be seen in this variant that the plastically deformable layer element 2e in the contact body le is clearly recessed laterally in the x-direction. As a result of the plastically deformable layer 2 spreading laterally, the contact bodies can be pressed into the layer 2.

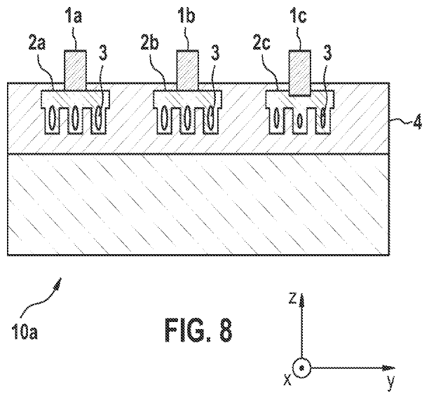

If small distances between the contact bodies 1a . . . 1n or contact lines without a continuous, plastically deformable layer 16 Substitute Specification 2 between the contact bodies 1a . . . 1n are desired and at the same time an oxide cover, it is beneficial to form hollow spaces or cavities 3 in the substructure in order to give the plastically deformable layer 2 space to spread. For this purpose, narrow trenches can, for example, be etched into the insulation layer 4, onto which the plastically deformable layer 2 is deposited. If the trenches are narrow enough, the aluminum sputtering process will produce the mentioned hollow spaces 3 in these trenches, as shown in the embodiment of the contact element 10a of FIG. 8. In the contact body 1c of FIG. 8, it can be seen that, as a result of the contact body 1c sinking into the plastically deformable layer element 2c, the hollow spaces 3 can be of different sizes in that the plastically deformable layer 2 is pressed into the hollow spaces by pressing the contact bodies 1a . . . 1n into it.

The tungsten contact bodies 1a . . . 1n can optionally also be coated with a further material (not shown in the figures) in order to prevent oxide formation on the surface thereof, for example. In this case, the further layer is preferably thinner than one third of a width of the contact bodies 1a . . . 1n. It can be particularly beneficial if the arrangement described herein is provided on both sides (moving and stationary side) of the MEMS relay 100. In this case, it is particularly beneficial to work with contact lines that are perpendicular to one another or arranged at least at an angle of more than 30 degrees to one another.

Advantageously, the plastically deformable aluminum layer can also be used as an electrical conductor path plane for wiring the MEMS relay 100. In this case, it can also be provided that not only a single, plastically deformable aluminum layer is provided, but several plastically deformable layers 2 or a layer with different materials can also be provided.

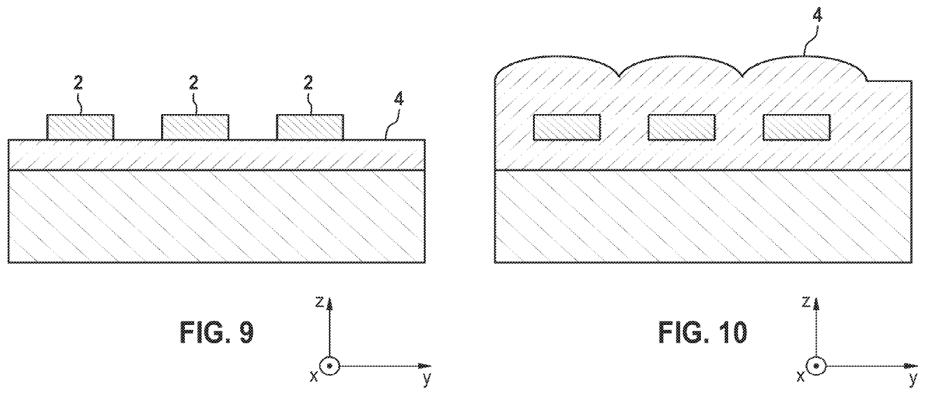

A principal flow of a production process for producing a proposed contact element 10a . . . 10n is explained below: First, a MEMS relay pre-process is carried out, which is not explained in more detail here for the sake of simplicity. Soft, plastically deformable material 2 is deposited and structured on at least a first contact region. Preferably used for this purpose is a material that can comprise aluminum or copper or gold or can consist of the mentioned materials, as shown in FIG. 9.

A sacrificial layer is applied to the contact region. Preferably, an insulation layer 4 in the form of an oxide layer is applied with a PECVD-TEOS deposition method, as shown in FIG. 10.

In a beneficial variant, the mentioned oxide layer is subsequently planarized with a CMP method in order to achieve a uniform surface of a uniform height level.

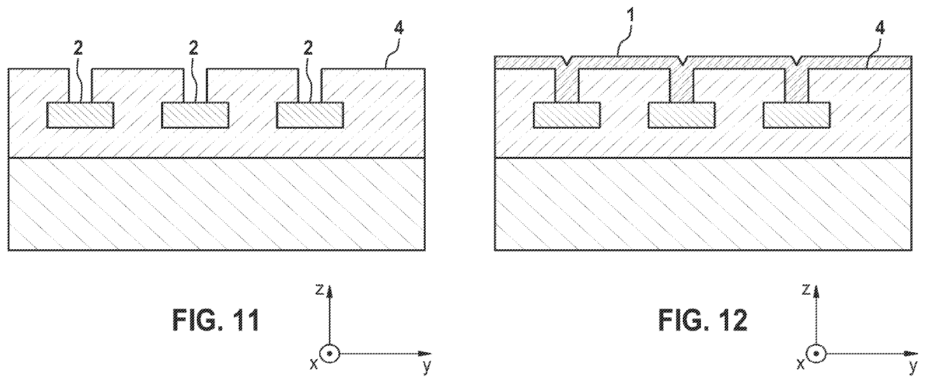

The mentioned sacrificial layer can subsequently preferably be structured with a plasma etching process and a paint mask, as shown in FIG. 11.

In a beneficial variant, an adhesive layer and a diffusion barrier are deposited, wherein Ti, TiN, Ta and TaN layers can, for example, be deposited for this purpose.

Subsequently, a hard, electrically conductive metal layer 1 is deposited, wherein tungsten or ruthenium or molybdenum can preferably be deposited. Preferably, a MOCVD (metal-organic chemical vapor deposition) method is used for this purpose, as shown in FIG. 12.

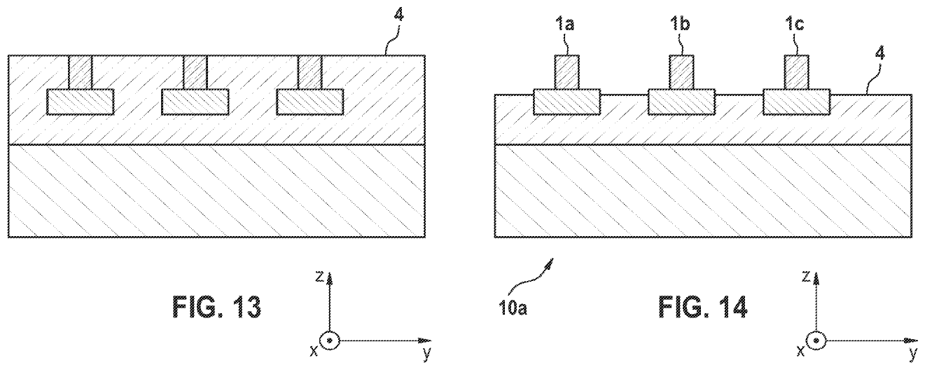

With a polishing process, the metal layer 1 at the surface is removed up to the oxide layer. By means of a selective polishing process, a very defined, equally high and very smooth tungsten surface can therefore be produced with this step, as shown in FIG. 13.

Finally, in a selective etching step, the insulation or oxide layer 4 is removed or somewhat etched back, as shown in FIG. 14.

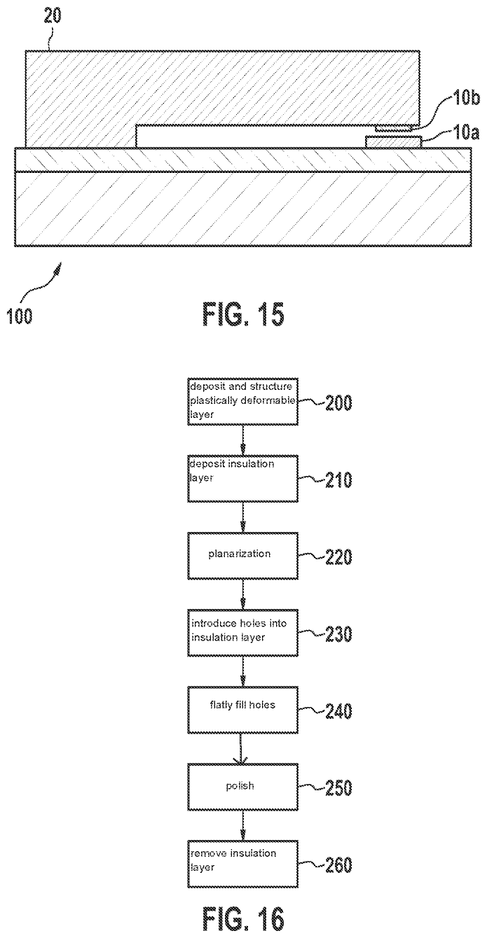

Thereafter, a subsequent MEMS relay process is carried out, which is not explained in more detail here for the sake of simplicity and which ultimately results in a MEMS relay 100 with a lever element 20 and the proposed contact elements 10a, 10b, as indicated in FIG. 15.

In an optional conditioning step, the contact element 10a . . . 10n is brought several times to strike against the contact bodies 1a . . . 1n of the MEMS relay 100 in order to anticipate a height adjustment of the contact regions even before delivery. This preferably takes place with an electrical drive voltage that is at least 10% higher.

This preferably also takes place at an increased temperature in order to allow the height adjustment to take place closer to the melting temperature. Preferably, this process takes place at at least 15° C. above the maximum permitted operating temperature.

With the approach proposed herein for MEMS relay contacts, low-resistance MEMS relays that can also switch inductive loads can, for example, in particular be produced.

FIG. 16 shows a principal flow of a proposed method for producing a proposed contact element 10a . . . 10n for a MEMS relay 100.

In a step 200, depositing and structuring of a plastically deformable layer 2 is carried out.

In a step 210, an insulation layer 4 is deposited onto the structured, plastically deformable layer 2.

In a step 220, a planarization step is carried out.

In a step 230, holes are introduced into the insulation layer 4.

The introduction of holes can be achieved by an etching process.

In a step 240, the holes are flatly filled with an electrically conductive material 1.

In a step 250, a polishing step of the electrically conductive material 1 is carried out with a stop on the insulation layer 4. In the polishing step, the electrically conductive material is removed from the insulation layer 4 so that the remaining, electrically conductive material is arranged only in the previously produced holes. The polishing step furthermore achieves a smooth and flat surface of the electrically conductive material arranged in the holes.

In a step 260, the insulation layer 4 is removed. The removal can be achieved by means of an isotropic etching step. The insulation layer 4 can be removed entirely up to the plastically deformable layer 2 so that the plastically deformable layer 2 is exposed at the top side of the layer. Alternatively, a remainder of the insulation layer can remain on the surface of the plastically deformable layer 2. In any case, the insulation layer 4 is removed in such a way that the contact bodies 1a . . . 1n are at least partially exposed.

A method for leveling contact bodies 1a . . . 1n of a contact element 10a . . . 10n of a MEMS relay is furthermore provided. In the mentioned method, the contact bodies 1a . . . 1n are subjected to a compressive force and are pressed into the elastically deformable layer 2 by the applied compressive force. By pressing, the contact bodies 1a . . . 1n are brought to a uniform height level. According to the present invention, the application of the compressive force to the contact bodies 1a . . . 1n is caused by striking a contact structure of the MEMS relay that can be moved relative to the contact element 10a . . . 10n, against the contact bodies 1a . . . 1n of the contact element 10a . . . 10n. The method for leveling can be performed after performing the manufacturing process and at the factory prior to the use of the MEMS relay. Alternatively or additionally, the method for leveling can be performed during operation of the MEMS relay. Thus, at any time during operation of the MEMS relay, a uniform height level of the contact body 1a . . . 1n can be achieved by striking the contact structure against the contact bodies 1a . . . 1n of the contact element 10a . . . 10n.

Although the present invention has been described above on the basis of specific exemplary embodiments, the person skilled in the art can also realize embodiments that were not or only partially disclosed above, without departing from the scope of the present invention.

1-15. (canceled)

16. A contact element of a MEMS relay, comprising:
a defined number greater than one of electrically conductive contact bodies, wherein the contact bodies are arranged at least partially within an electrically conductive, plastically deformable layer, wherein a hardness of the plastically deformable layer is less than a hardness of the contact bodies, wherein, by applying a compressive force to the contact bodies, the contact bodies can be pressed into the plastically deformable layer and brought to a substantially uniform height level, and wherein the plastically deformable layer is arranged at least partially within an insulation layer.

17. The contact element according to claim 16, wherein the contact bodies have elongated or round cross-sections.

18. The contact element according to claim 16, wherein the plastically deformable layer is exposed at a top side.

19. The contact element according to claim 16, wherein the plastically deformable layer is arranged entirely within the insulation layer, and wherein the contact bodies are arranged in recesses of the insulation layer and are connected to one another via the plastically deformable layer.

20. The contact element according to claim 16, wherein the contact bodies are arranged on separated elements of the plastically deformable layer.

21. The contact element according to claim 20, wherein the separated elements of the plastically deformable layer are at least partially exposed laterally.

22. The contact element according to claim 20, wherein, within the separated elements of the plastically deformable layer, at least one hollow space is respectively formed, into which the plastically deformable layer can be pressed.

23. The contact element according to claim 16, wherein the plastically deformable layer is made of a material including aluminum and/or copper and/or gold; and wherein the contact bodies are made of a material including tungsten and/or ruthenium and/or molybdenum.

24. The contact element according to claim 16, wherein exposed surfaces of the contact bodies are approximately <2 μm and edge radii of the contact bodies are approximately <0.5 μm.

25. The contact element according to claim 16, wherein the contact bodies are arranged at a distance of approximately <10 μm to one another.

26. The contact element according to claim 16, wherein the contact bodies are arranged in an array.

27. The contact element according to claim 16, wherein a total number of the contact bodies is such that it results in an electrical target resistance of the contact element.

28. The contact element according to claim 16, wherein the contact bodies are coated with a material that substantially prevents oxide formation at a surface of the contact bodies.

29. A method for producing a contact element for a MEMS relay, comprising the following steps:
depositing and structuring a plastically deformable layer;
depositing an insulation layer onto the structured, plastically deformable layer;
introducing holes into the insulation layer;
filling the holes with an electrically conductive material;
carrying out a polishing step of the electrically conductive material with a stop on the insulation layer; and
removing the insulation layer.

30. A method for leveling contact bodies of a contact element of a MEMS relay,
wherein the contact element includes:
a defined number greater than one of electrically conductive contact bodies, wherein the contact bodies are arranged at least partially within an electrically conductive, plastically deformable layer, wherein a hardness of the plastically deformable layer is less than a hardness of the contact bodies, wherein, by applying a compressive force to the contact bodies, the contact bodies can be pressed into the plastically deformable layer and brought to a substantially uniform height level, and wherein the plastically deformable layer is arranged at least partially within an insulation layer;
wherein the method comprises:
applying a compressive force to the contact bodies and pressing the contact bodies into the plastically deformable layer of the contact element to a uniform height level of the contact bodies, wherein the application of the compressive force is caused by striking a contact structure of the MEMS relay that is arranged movably relative to the contact element, against the contact bodies.
